(19) United States
(12) Patent Application Publication
(10) Pub. No.: US 2011/0056875 A1
(43) Pub. Date: Mar. 10, 2011

(54) FILTER APPARATUS AND FILTER ELEMENT FOR SUCH A FILTER APPARATUS

(76) Inventors: Gerhard Stehle, Konstanz (DE); Sven Wozniak, Konstanz (DE); Günther Müller, Salem (DE)

(21) Appl. No.: 12/735,988

(22) PCT Filed: Dec. 18, 2008
(86) PCT No.: PCT/EP2008/010789

§ 371 Date: Sep. 23, 2010

(30) Foreign Application Priority Data
Mar. 4, 2008 (DE) 10 2008 012 521.0

(51) Int. Cl. B01D 35/027; B01D 29/23

(52) U.S. Cl. 210/172.1

(57) ABSTRACT

The invention relates to a filter apparatus, especially intended for incorporation into a fluid reservoir tank (10) with at least one preferably exchangeable filter element (18) through which fluid can flow from the inside outward and which is surrounded, in each case maintaining a presettable radial distance and with formation of a fluid flow space (66), by a housing wall (44) which has a plurality of passage sites of which some are arranged below the particular adjustable fluid level (68) in the reservoir tank (10) and the rest are arranged above this fluid level (68). The invention further relates to a filter element for this kind of apparatus.

The invention relates to a filter apparatus, in particular intended for installation in a fluid reservoir tank. The corresponding engineering solutions are also referred to, according to the professional terminology of the field, as in-tank solutions. Furthermore, the invention relates to a filter element for this kind of filter apparatus.

EP 1 419 807 B1 discloses an in-tank filter apparatus, with an exchangeable filter element, which can be accommodated in a reservoir tank for fluids, in particular in the form of hydraulic fluid, and which separates a dirty side from a clean side. Furthermore, the prior art solution is provided with a receptacle, which holds in a removable manner the filter element and which has a passage for the filtered fluid in the direction of the clean side of the tank. In this case there is a retaining element, which inhibits any passage of foreign bodies through the opening of the passage to the clean side of the tank. In the engineering solution known from the prior art, a cone serves as the retaining element. The shell of the cone is perforated so that when the filter element is changed, foreign bodies are prevented from passing to the clean side of the tank, but the fluid in the element can drain, provided that it is exchanged for a new element. The installed filter element has a pleated filter mat, which is supported by a support tube jacket downstream of the specified direction of flow.

A comparable in-tank solution is also disclosed in DE 10 2004 014 149 B4, where the prior art filter apparatus has at least one filter element with a pleated filter mat, which can be received in a filter housing, which can be connected to a fluid system, in particular in the form of a hydraulic reservoir tank, through fluid connections by means of a connection system in such a way that a fluid is enabled to circulate. The filter housing can be mounted in a removable manner on said fluid device by means of an attachment mechanism. This attachment mechanism is embodied in the form of a bayonet catch, which can be locked and released by rotating the filter housing. In this context the attachment mechanism has at least one moveable locking element which is configured in the manner of a rotationally mounted rotary disk valve, which in the locking position blocks the respective fluid connection, which can be assigned to said rotary disk valve. When the rotary disk valve moves into an open position, it releases said respective fluid connection for the passage of fluid.

During filtration with such in-tank filter apparatus, there is the basic tendency, especially in the event of high working pressure conditions and/or large quantities of fluid, for the fluid that is to be cleaned to splash and produce foam during its passage through the respective filter element. The tendency to produce foam is caused by the gas bubbles, in particular bubbles of air, which are routinely entrained in the fluid, especially in the form of hydraulic oil, in the preceding hydraulic working circuit. This is especially the case when such filter apparatus are used for mobile machines, such as excavators, wheel loaders, or telescopic loaders, etc., that are largely provided with a working hydraulic system, for example, in the form of hydraulic cylinders, which can be supplied and controlled by pumps. In order to improve the prior art solutions in such a way that the fluid that produces foam and splashes out of the filter element is prevented from making direct contact with the rest of the fluid or oil volume in the reservoir tank, the filter elements are confined in suitable enclosing housings inside the tank. Each enclosing housing forms a kind of presettling space or pre-chamber, in which the fluid to be cleaned can become quiescent, and any gas bubbles that may have formed can escape upwards as a function of their buoyancy force. However, the said settling chambers occupy a relatively large amount of design space inside the actual tank volume, so that ultimately the result is a reservoir tank that in its entirety is too large in design. Especially if the working pressure conditions are high and/or the amounts of fluid to be filtered are very large, the volume of the pre-chambers is routinely insufficient to allow the oil to become adequately quiescent before delivery into the actual reservoir tank.

Therefore, working on the basis of this prior art, the object of the invention is to further improve the known solutions in such a way that they can also be used unconditionally for mobile applications and that while maintaining the advantages of cleaning the fluid especially well, a space-saving and cost-effective solution is provided, with which it is easy to deliver the fluid to a reservoir tank even in the event of high pressure conditions and/or very large quantities of fluid.

This kind of problem is solved by a filter apparatus having the features disclosed in claim 1 in its entirety as well as a filter element having the features disclosed in claim 10.

The filter apparatus according to the invention has at least one preferably exchangeable filter element, through which the fluid flows from the inside to the outside and which is surrounded, in each case maintaining a presettable radial distance and with formation of a fluid flow space, by a housing wall, which has a plurality of passage points, of which some are arranged below the variable fluid level in the reservoir tank and the rest of the passage points are arranged above this fluid level. Owing to this arrangement, the fluid that is cleaned by the respective filter element and that enters into the fluid flow space flows in a laminar manner through the assignable passage points into the reservoir tank in the area of the respective flow level and above the same. As a result, the undesired formation of splashes and foam as the fluid emerges is reliably avoided. Owing to the pressure differential between the inflowing, uncleaned fluid and the outflowing, cleaned fluid, the latter can be raised above the fluid level in the fluid flow space in the tank, with simultaneous distribution along the inside of the housing wall with the passage points, to which end capillary effects may also contribute. Then the resulting uniform fluid film makes it possible for the fluid to emerge without splashing and foaming out of the said passage points at right angles to the housing wall.

To the extent that the cleaned fluid in the fluid flow space exhibits any gas bubbles, like air bubbles, they are also delivered to the respective passage point that collects the bubbles for a delivery inside the reservoir tank that is close to the fluid level. To this end the bubbles become larger in their volume preferably for the purpose of an easier delivery. In this way the gas bubbles obtain a higher buoyancy force and separate more easily from the emerging, cleaned fluid volume, in particular in such a manner that there is no formation of either foam or splashes that would otherwise promote the entrainment of gas or air in the emerging fluid volume. To the extent that the fluid volume is substantially degassed inside the reservoir tank, it is possible to reliably avoid any malfunction due to gas bubbles and any damage to the working hydraulic system under normal operating conditions, when the fluid is correspondingly removed and conveyed to the working hydraulic system. Owing to the homogeneous emergence characteristics, the floating particulates that may still be in the tank are not swirled up. Therefore, it is possible to dispense altogether with the presettling chambers that, moreover, occupy design space in the tank.

Should the fluid level and, thus, the oil level, drop below the bottommost passage points, a circumstance that could be the case, for example, when switching off the working hydraulic system of the machine, it cannot be ruled out that an air cushion will collect there, a state that is obviously not desired, as already stated above. In order to take active steps against such a risk, an especially preferred embodiment of the filter apparatus according to the invention provides that the housing wall is configured so as to be closed in the direction of its underside and that an additional sleeve is installed in the fluid flow space. This additional sleeve has additional passage points below the assumed lowest fluid level and otherwise forms up to and above this level a closed sleeve surface.

As an alternative, it can also be provided in order to remedy this effect that each filter element that is installed exhibits with its outer sleeve, which forms a kind of support tube—in particular, a support cylinder—a non-perforated, closed sleeve component as far as below the minimum oil level (fluid level) expected in the tank. Then below that, there are, accordingly, the additional passage points, preferably in the form of a perforation in the said support tube sleeve, in order to avoid the said air cushion. Thus, there is the possibility of installing the sleeve as a stand-alone add-on component into the fluid flow space or of modifying the outer support tube of the filter element in such a way that the described sleeve function is achieved.

Other advantageous embodiments of the filter apparatus according to the invention are the subject matter of the other dependent claims.

The solution according to the invention is explained in detail below on the basis of a variety of embodiments with reference to the drawings, which show in principle, but not according to scale

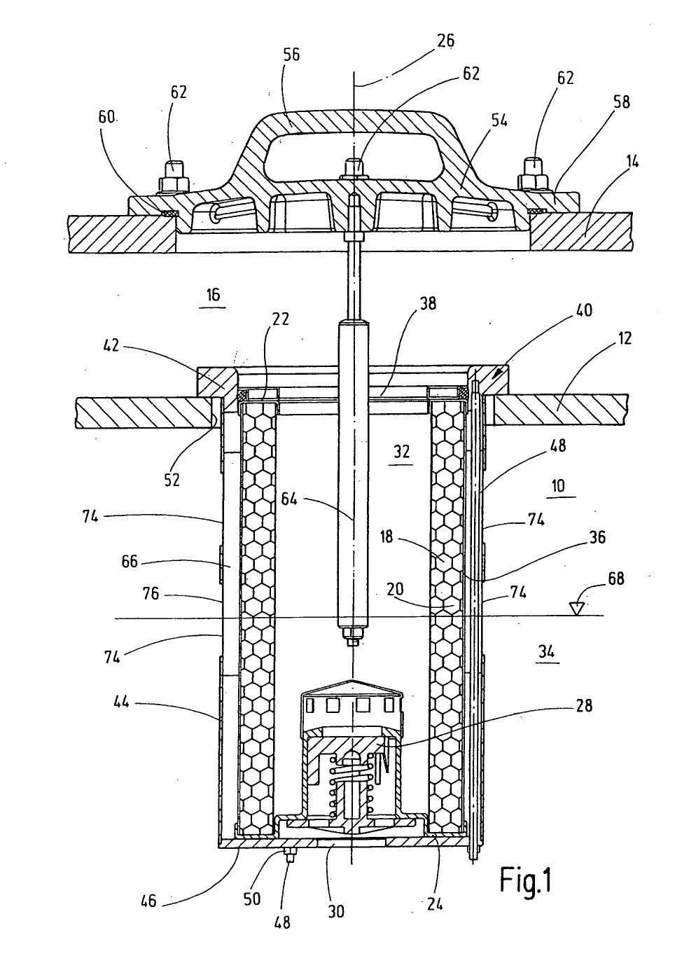

FIG. 1 shows a longitudinal sectional view of a first embodiment of the filter apparatus according to the invention;

FIG. 1A shows a graphical rendering corresponding to FIG. 1, but depicted in a different sectional plane;

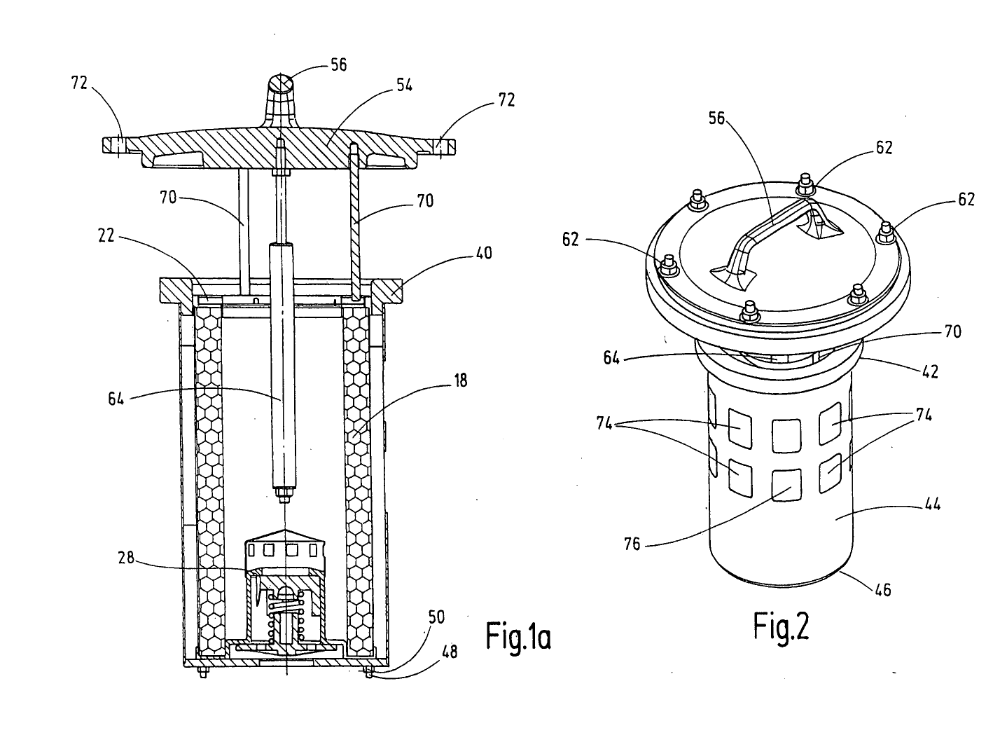

FIG. 2 shows a perspective outside view of the filter apparatus according to FIG. 1; and

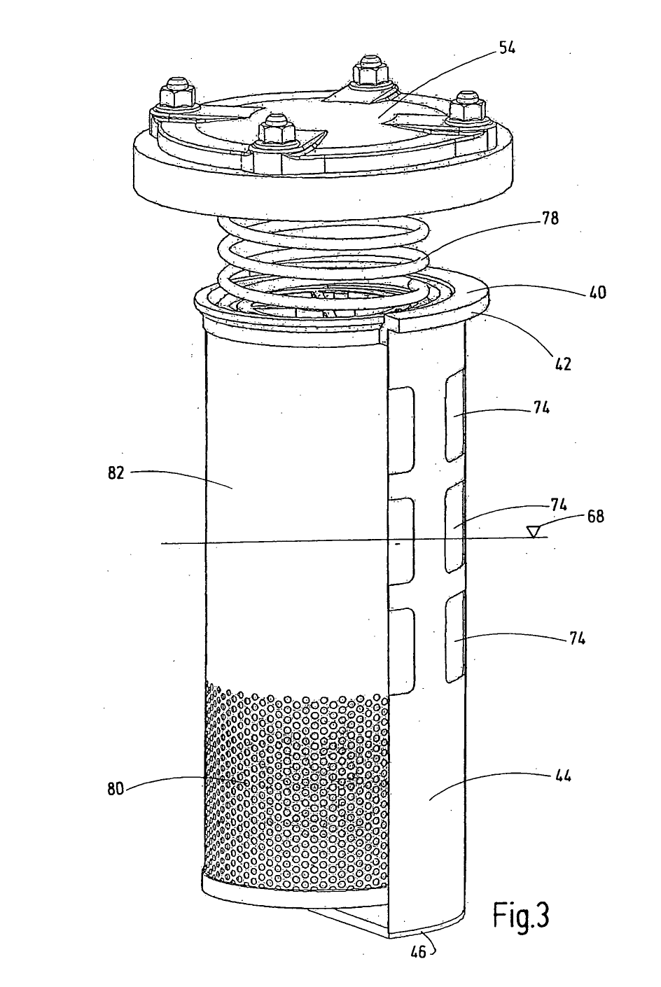

FIG. 3 shows a partially cut open view of a second embodiment of the filter apparatus;

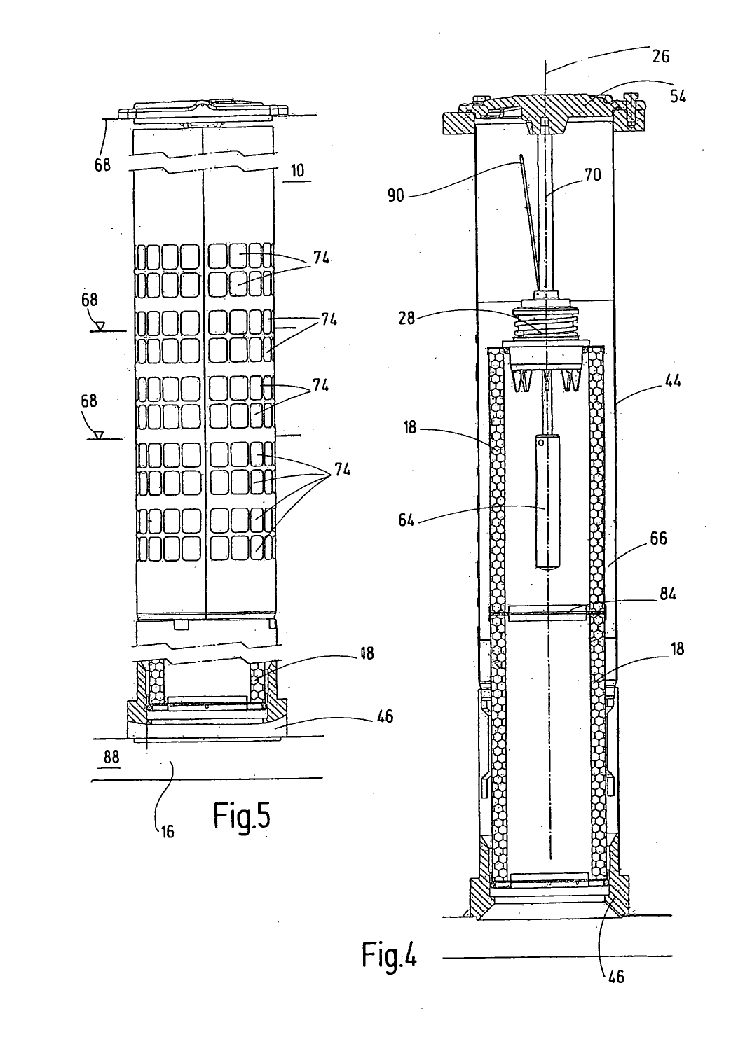

FIGS. 4 and 5 shows a third embodiment of the filter apparatus, shown once as a longitudinal sectional view, and once as a side view, where the bottom base member is also shown as a sectional view.

The filter apparatus, shown in FIG. 1, is intended for installation in a container-like fluid reservoir tank 10, comparable to the installation situation according to the EP 1 419 807 B1. The drawing according to FIG. 1 shows only the upper tank wall 12 of the fluid reservoir tank 10 as well as an associated receiving wall 14 for anchoring the filter apparatus. Between these wall sections 12, 14 runs an inflow channel 16 for the fouled fluid, coming, for example, from the hydraulic circuit of a working hydraulic system (not depicted in detail) of a construction machine or the like.

Furthermore, the filter apparatus has a filter element 18 with a preferably pleated filter mat 20. Otherwise the filter element 18 is made essentially like a circular cylinder. The filter mat 20 extends between an upper end cap 22 and a bottom end cap 24 as parts of the filter element 18. The bottom end cap 24 has a conventional bypass valve 28, which is positioned in the middle and extends coaxially to the longitudinal axis 26 of the filter apparatus. When the filter mat 20 is clogged with contaminants, this bypass valve opens and allows the fluid to bypass the filter mat 20 in the uncleaned state and to drain through a bottom bypass port 30 into the reservoir tank 10. Since the filter mat 20 is traversed by flow from the inside to the outside, i.e., the flow takes place from the inside 32 of the filter element 18 in the direction of the interior 34 of the fluid reservoir tank, the filter mat 20 is enveloped by a support tube or a support jacket 36 for the purpose of reinforcing towards the outside. This support tube 36 is configured so as to be preferably circularly cylindrical and has corresponding passage openings (not shown in detail) for the passage of fluid that has been cleaned by means of the filter mat 20. However, a suitably shaped support jacket (not shown) could also conform with the outer contour of the pleated filter mat and, thus, provide the support function in order to enhance the pressure stability of the element towards the outside. Even this kind of support jacket has the corresponding passage openings for the fluid medium. The fluid entry of the uncleaned fluid, coming from the inflow channel 16, occurs through the upper inflow opening 38 of the filter element in the direction of the said interior 32 of the same.

The filter element 18 is received in a housing, all of which is designated with the reference numeral 40. The upper side of this housing has a flange-like expansion 42, which supports the filter apparatus in this area on the upper side of the upper tank wall 12. Adjoining the said expansion 42 in the downward direction is a cylindrical housing wall 44, which is designed so as to be closed on its underside 46, save for the said bypass port 30. Preferably the pertinent underside 46 of the housing wall 44 is made as a stand-alone bottom part; and the housing wall 44 is supported with its respective free end on a shoulder-like step of the underside 46 as well as on the flange-like expansion 42. In order for the described combined system of the housing 40 to remain in the assembled state, as shown in FIG. 1, the outer periphery in the direction of the filter mat 20 with the support tube 36 has retaining rods 48, of which FIG. 1 shows only one retaining rod 48 in its entirety. Of the two other retaining rods 48 that are installed for this purpose, FIG. 1 shows for the sake of simplicity only one additional rod 48 with its bottom connection end, projecting from below the underside of the bottom part 46. In this area the respective retaining rod 48 is screwed together with a threaded nut 50; and the upper end of the respective retaining rod 48 is rotated into the flange-like expansion 42 by means of a corresponding internal thread. As a result, the housing wall 44 between the expansion 42 and the bottom part 46 can be securely anchored under a specified prestress.

In order to be able to install the housing 40 into the upper tank wall 12, this upper tank wall has a corresponding circularly cylindrical recess 52, the diameter of which is at least greater than the outside diameter in the area of the transition between the flange-like expansion 42 and the outer periphery of the housing wall 44. Furthermore, there is a lid member 54 as a part of the filter apparatus. This lid member has a handle 56 to make it easier to install the filter apparatus into the illustrated tank 10 and to remove it from the same. The lid member 54 has a shoulder-like expansion 58, which sits on the upper side of the receiving wall 14; and an offset of the expansion 58 reaches into the clear inside diameter of the receiving wall 14 so as to make contact with the same. In order to seal the fluid, this area has an annular sealing element 60 of the conventional design. As shown especially in FIG. 2, there are attachment screws 62 that are positioned opposite each other and diametrically to the longitudinal axis 26 of the apparatus. These attachment screws are used to fasten the lid member 54 to the receiving wall 14. After slackening the screws 62, the filter apparatus can be removed from the tank 10 and installed again in the reverse sequence of assembly. Such assembly operations are necessary, to the extent that a used filter element 18 is to be exchanged for a new element.

A magnetic bar 64 runs concentrically to the longitudinal axis 26. This magnetic bar has, in particular, the function of a permanent magnet and is securely attached, when viewed in the viewing direction of FIG. 1, with its upper end in the lid member 54, in particular is screwed into said lid member. With its other opposite free end, said magnetic bar extends through the inside 32 of the filter element 18. Such a magnetic bar 64 makes it possible to separate out the magnetizable metal components in the fluid to be filtered. Both the magnetic bar 64 and the bypass valve 28 are provided optionally and are not mandatory for the function of the filter apparatus as a whole.

Furthermore, FIG. 1 shows that the cylindrical housing wall 44 occupies a presettable radial distance from the outer peripheral surface of the filter element 18, so that in this respect a fluid flow space 66 is formed. The pertinent fluid flow space 66 extends parallel to the outer peripheral surface of the filter element 18. In particular, it extends in the axial longitudinal direction parallel to the longitudinal axis 26 of the apparatus between the upper side of the bottom part 46 and the bottom side of the flange-like expansion 42. Furthermore, the fluid flow space 66 is defined outwards in essence by the housing wall 44 and inwards by the outer peripheral surface of the filter mat 20. To the extent that a support jacket or a support tube 36 is used for the filter mat 20, the corresponding outer peripheral surface forms the limiting boundary for the fluid flow space 66.

The embodiment according to FIG. 1 shows a fluid level 68 inside the reservoir tank 10; and the filter element 18 and, thus, the fluid flow space 66 lie partially below the level 68 and partially above the same. As a function of the inflowing fluid volume over the inflow channel 16 or the outflowing volume required for the working hydraulic system, the fluid level 68 varies in relation to the illustrated momentary position in FIG. 1. Moreover, the fluid flow space 66 is not impaired as a flow space with the exception of the penetration of the individual retaining rods 48 (cf. FIG. 1).

FIG. 1a shows a different sectional plane than in FIG. 1, but is otherwise intended to relate in essence to the same filter apparatus. In this case the filter apparatus has individual connecting rods 70, which were omitted in FIG. 1 for the sake of a better overview. FIG. 1a shows only two of a total of three connecting rods 70. The ends of the connecting rods 70 are connected to the lid member 54. Otherwise, the connecting rods rest against the upper end cap 22 of the filter element 18, in order to hold the latter in the illustrated installation position. In this respect there is the option of removing from the housing 40 only the filter element 18 that is to be exchanged by removing the lid member 54; otherwise, said housing remains in its installation position on the upper tank wall 12. Other approaches to the solution are possible here, for example, in the sense that in the event that the crosspieces 70 are permanently connected to the housing 40, even the housing together with the filter element 18 can be removed, if desired, by way of the lid member 54. For the sake of greater simplification in relation to FIG. 1, FIG. 1a no longer shows the walls 12, 14 or the attachment screws 62, which extend through the corresponding recesses 72 in the lid member 54. As the orientation of the handle 56 shows, the drawing according to FIG. 1a is swiveled by 90 degrees out of the drawing plane according to the drawing from FIG. 1.

Furthermore, it is clear from FIG. 2, which shows an external view of the filter apparatus from FIG. 1, that the housing wall 44 has window-like passage openings 74, which form circumferential groups on the periphery and are positioned one above the other in the manner of a ring. At the same time the two adjacent groups have the same axial distance in relation to each other; and the individual passage openings 74 inside a group also exhibit the same amount of spacing between each other in the radial direction. It is also clear from the drawing in FIG. 1 that at the given fluid level 68, the bottom group of passage openings 74 is still covered by the fluid level; and the higher level group of passage openings 74 empties on the level upper side into the interior of the tank 10. In the present embodiment there is a screen or lattice structure layer 76 inside the housing wall 44 and resting against its interior. This screen or lattice structure layer forms a continuous cylinder jacket and extends over the edge of all of the window-like passage openings 74 that are all the same in design. In order for the structure layer 76 to remain against the inside of the housing wall 44, it can be suitably fastened by spot welding (not illustrated in detail).

However, instead of a single structure layer 76, it is also possible, in terms of amount, for each window opening 74 to have its own dedicated lattice that then covers from the inside this window opening with its edge-sided projecting length. The structure layer 76 can be embodied by an expanded metal lattice as well as any other kind of thin meshed lattice or network, even in the form of a fabric structure with warp and weft threads. Preferably, the structure layer 76 that is inserted in each case for the plurality of passage points exhibits for each passage point an opening cross section of less than one millimeter. The choice of the clear opening cross sections for the passage points of the structure layer depends on the environmental conditions, like the viscosity of the fluid that is fed in, especially in the form of hydraulic oil, which ultimately also depends on the ambient temperature values. The window openings 74 are configured preferably in the shape of a rectangle, but other opening geometries would be just as possible in this respect.

If at this point the filter apparatus according to FIGS. 1, 1A, and 2 is put into service, then the fluid flows through the filter mat 20 from the inside to the outside and, in so doing, is cleaned. Since some of the fluid that is stored in the tank 10 and is below the level 68 flows into the bottom passage openings 74, the inflow space 66 that is below the level 68 fills up with fluid, with the consequence that the subsequent fluid that continues to flow in from the inside 32 is pushed upwards, so that the result is a film-like hollow column of fluid in the fluid flow space 66. This fluid rests against the inside of the housing wall 44 and against the passage points of the screen or lattice structure layer 76 that is perforated for this purpose. The resulting fluid arrangement that rises above the fluid level 68 flows through the passage points into the window-like passage openings 74, a flow that is largely laminar. At the same time splashing or foaming events during this passage are reliably avoided. As a function of the fluid volume and the fluid pressure, generated by way of the fluid feed into the inflow channel 16, the resulting laminar flow can emerge in the area of the fluid level 68 or correspondingly above the same. As a function of the size of the volume for the fluid flow space 66 and given a suitably narrow radial layout, i.e., with a negligible degree of radial spacing, a supporting capillary effect may be produced for the upward movement in the direction of the outside of the filter element 18.

As a function of the mesh width for the structure layer 76, the clear opening cross sections for the passage points may be chosen in such a way that any gas bubbles, such as air bubbles, that are in the cleaned fluid can settle on such a perforated structure layer 76. In this case if the gas is to be released close to the fluid level, then the bubbles are collected on the structure layer 76 and are increased in volume under the influence of their surface tension for easier release, so that they can rise upwards out of the filter apparatus effortlessly like the CO₂ beads in a carbon dioxide containing beverage, so that the fluid in the tank is effectively degassed. Since the hydraulic working devices are often sensitive to the introduction of gas, this approach effectively rectifies the risk of a malfunction.

Instead of the cylindrical peripheral wall 44 that is a component of the apparatus housing and that is closed (as illustrated in FIGS. 1, 1A and 2) with the exception of the window-like openings 74, said peripheral wall 44 can also be replaced in its entirety or for the most part by a cylindrical structure layer 76 having corresponding passage points (not illustrated). Another alternative is to configure the structure layer 76 as multiple layers, so that the result is a stiffer design for the housing wall 44, in order to be able to reliably control the resulting pressure differentials in the tank 10. Instead of the illustrated embodiment that provides for the individual passage points the same opening cross section, it would also be conceivable in a suitably modified design to change the clear opening cross section in the direction of the rising fluid flow in the fluid flow space 66, in particular, to make the same shape change, in order to achieve in this way an improvement in the fluid rise in the fluid flow space 66.

The following embodiments are described only insofar as it is necessary to show the major distinction with respect to the preceding embodiment. Hence, for the same components with the same function the same reference numerals that were used above are used here; and the resulting designs also apply to the modified design variants.

The embodiment according to FIG. 3 has, instead of the connecting rods 70, a compression spring 78 that extends between the lid member 54 and the housing 40. When the lid member 54 is firmly secured, the housing 40 of the filter apparatus pushes against the top side of the upper tank wall 12. Instead of the previous two groups of window-like passage openings 74, the engineering solution according to FIG. 3 has three groups that are positioned one above the other. The fluid level in turn is indicated, as an example, with a triangle under the reference numeral 68. The essential feature in the modified embodiment according to FIG. 3 is that below the lowest possible fluid level 68 there are additional passage points 80 in the form of a perforation in the cylindrical sleeve 82. However, the corresponding sleeve 82 with its closed surface areas empties below the lowest conceivable fluid level 68 and below that point has additional passage points 80.

The said sleeve 82 can be inserted into the fluid flow space 66 as a stand-alone component. However, there is also the possibility that the illustrated sleeve 82 is an essential part of the filter element 18, especially in the circumference of the additional passage points 80, and insofar envelops the filter mat 20 of the filter element 18 as a support tube or support jacket. Should the oil level in the form of the fluid level 68 drop below the illustrated window-like passage openings 74, an air cushion could collect there when the working hydraulic system is switched off. However, this air cushion does not develop, if the outer support cylinder of the filter element 18 has, according to the illustration from FIG. 3, a non-perforated section as far as below the minimum possible oil level. According to the drawing from FIG. 3, this non-perforated section can also be implemented with a separate sleeve 82 that is made, for example, of a plastic material.

In the embodiment according to FIGS. 4 and 5, two filter elements 18 are arranged one above the other in a coaxial arrangement in relation to the longitudinal axis 26 of the filter apparatus. In this case the bottom filter element 18, viewed in the viewing direction of FIG. 4, is intended for the fine filtration; and the element that is positioned above is intended for the coarse filtration. If the fine filtration element 18 is clogged with contaminants, then it is still possible to conduct a coarse filtration by way of the upper element 18. In the present embodiment under discussion the filter apparatus is configured so as to be closed, except for the bypass valve 28 that is now positioned at the very top. At this point the fouled fluid flows through the passage on the bottom side 46 into the respective filter element 18. The two filter elements 18 are separated from each other in the middle by means of a spacing mechanism 84 that has a fluid passage in the center. Then as a function of the degree of contamination for the bottom fine filter element 18, a portion of the fluid flows noticeably through the upper coarse filter 18. Otherwise, the filtered fluid flows from the bottom filter element 18 into the fluid flow space 66 that has already been described above.

It is especially clear from FIG. 5 that this time there are two groups of window-like passage openings 74, in total, five groups of two that are arranged one above the other. Furthermore, FIG. 5 shows the two anticipated bottom and upper fluid levels 68 (oil level minimum/oil level maximum). FIG. 5 also shows that this time the filter apparatus extends between a tank upper side 68 and a bottom tank chamber 88 that for this purpose forms the inflow channel 16 for the fouled fluid. In order to anchor the two filter elements 18 that are positioned one above the other with their respective end caps on the lid member 54, there is this time a single connecting rod 70 that is arranged in the middle. The filter arrangement can be pulled out of the housing wall 44 by means of a pivotable handle 90.

The inventive filter apparatus according to the illustrated embodiments makes it possible to receive dirt particles in the 10 μm range without further effort. Fouled filter elements 18 can be easily exchanged; and the special housing arrangement makes it possible to actively rectify the risk of recontamination. The magnetic bar 64 that is used in each case and configured as a magnetic core is clearly visible from the outside during maintenance work and, if desired, can be cleaned by hand with a suitable cloth. Moreover, the magnetic bar 64 is configured in such a way that the foreign particles adhere uniformly to it without any accumulation of contaminants in the area of the bypass valve 28, a state that might have an adverse effect on the operational reliability of the valve. The element is well supported between the wall sections 12 and 14 especially in the event of vehicle movements, so that the result is not an inadvertent removal of the components of the filter apparatus with the consequence of an unintentional bypass flow of the unfiltered fluid to the clean side of the tank arrangement. On the whole, the filter apparatus according to the invention enables a modular concept, a feature that contributes to lowering the production costs.

However, it is especially important that the engineering solution according to the invention makes possible a homogeneous laminar flow of the cleaned fluid from the filter apparatus back into a tank without producing any splashing effects or undesired foam. In addition, the inserted structure layers exhibiting the fine mesh passage openings improve the degassing properties and preclude with certainty any deleterious introduction of air into the hydraulic medium.

In the Claims

1. A filter apparatus, in particular intended for installation in a fluid reservoir tank (10), with at least one preferably exchangeable filter element (18), which is traversed by a fluid flow from the inside to the outside and which is surrounded, in each case maintaining a presettable radial distance and with formation of a fluid flow space (66), by a housing wall (44), which has a plurality of passage points, of which some are arranged below the variable fluid level (68) in the reservoir tank (10) and the rest of the passage points are arranged above this fluid level (68).

2. The filter apparatus, according to claim 1, characterized in that the passage points have the same clear opening cross section, or that the clear opening cross sections increase at least partially, preferably uniformly, in the direction of the rising fluid flow in the fluid flow space (66).

3. The filter apparatus, according to claim 1, characterized in that the respective passage points are part of at least one screen or lattice structure layer (76) that covers the window-like passage openings (74) arranged in the housing wall (44).

4. The filter apparatus, according to claim 3, characterized in that the respective structure layer (76) is disposed in front of the housing wall in the flow direction of the fluid through the passage openings (74) in the housing wall (44) and arranged preferably in the fluid flow space (66) and envelops with an edge-sided overlap the respectively assignable window-like passage openings (74).

5. The filter apparatus, according to claim 3, characterized in that the passage points that are disposed inside the housing wall (44) and arranged in groups are spaced equidistant apart from each other in the radial and/or in the axial extension direction.

6. The filter apparatus, according to claim 1, characterized in that the cleaned fluid, flowing into the fluid flow space (66) and located in the area of the respective fluid level (68) and above the same, flows away in a laminar manner through the assignable passage points into the reservoir tank (10).

7. The filter apparatus, according to claim 3, characterized in that the cleaned fluid, located in the fluid flow space (66), releases any gas bubbles, like air bubbles, to the respective structure layer (76), which is perforated with the passage points and collects the bubbles for a delivery of the gas close to the fluid level, and said bubbles increase in their volume preferably for the purpose of an easier delivery.

8. The filter apparatus, according to claim 1, characterized in that defined by the upper side of the housing wall (44) and by a lid member (54) of the apparatus, an inflow channel (16) for the fouled fluid is formed, or that the inflow channel (16) is formed by a penetration on the bottom side (46) of the housing wall (44), and that the housing wall (44) connected to the lid member (54) forms a closed circumferential section.

9. The filter apparatus, according to claim 1, characterized in that the housing wall (44) is configured so as to be closed in the direction of its underside (46) and that an additional sleeve (82) is inserted into the fluid flow space (66), with the said sleeve having additional passage points (80) below the expected lowest fluid level (68) and forming up to that point and above this level (68) a closed sleeve surface.

10. A filter element for a filter apparatus, according to claim 1, characterized in that the filter material, preferably in the form of a pleated filter mat (20), is enveloped by a support tube jacket as the sleeve (82), said support tube jacket having at least one additional passage point (80) below the expected minimum fluid level (68) in the reservoir tank (10) and otherwise forming a closed sleeve surface.
